(19) United States
(12) Patent Application Publication
(10) Pub. No.: US 2025/0005938 A1
(43) Pub. Date: Jan. 2, 2025

(54) SAFETY MONITOR FOR THE INTEGRITY OF AN INSTRUMENT CLUSTER IN A VEHICLE

(71) Applicant: Intel Corporation, Santa Clara, CA (US)

(72) Inventors: Cornelius BUERKLE, Karlsruhe (DE); Fabian OBORIL, Karlsruhe (DE)

(21) Appl. No.: 18/534,766

(22) Filed: Dec. 11, 2023

(30) Foreign Application Priority Data
Jun. 29, 2023 (DE) 10 2023 117 224.7

(51) Int. Cl. G06V 20/59; B60K 35/28; B60K 35/29; G06V 10/75; G06V 10/82; G06V 10/94; G06V 10/98

(52) U.S. Cl. CPC G06V 20/59; G06V 10/75; G06V 10/82; G06V 10/993; B60K 35/28; B60K 35/29; B60K 2360/167; B60K 2360/178; B60K 2360/1868; B60K 2360/1876; G06V 10/94

(57) ABSTRACT

A safety device comprising: an image data analyzer configured to receive data representing an image for display on a vehicle display; to identify a safety-relevant part of the image based on the data; to determine a value representing the identified safety-relevant part of the image; and a safety checker configured to compare the value with a reference value; wherein the safety device is configured to implement a first mode of operation if the comparison of the value with the reference value is within a comparison range; and to implement a second mode of operation different from the first mode of operation if the comparison of the value with the reference value is outside the comparison range.

### CROSS-REFERENCE TO RELATED APPLICATIONS

This application claims priority to German Application DE 10 2023 117 224.7, filed on Jun. 29, 2023, the entire contents of which are incorporated herein by reference.

### TECHNICAL FIELD

Various aspects of this disclosure relate to strategies for monitoring and/or ensuring the integrity of vehicle display data, in particular of safety-relevant vehicle display data displayed in a vehicle display or instrument cluster.

### BACKGROUND

A current trend in vehicles is to replace the classic analog display or instrument cluster with one or more displays. This allows additional information such as route guidance, playlists, etc. to be displayed alongside standard information such as speed and warning icons. Furthermore, the use of such a display enables additional design freedom, customization and a more modern aesthetic.

However, there are certain challenges associated with using displays in this way. One of these challenges is that some of the information to be displayed is “safety-critical” information. That is, some of this information may be critical to the safe operation of the vehicle, and the accurate display of this safety-critical information should be ensured so that the driver can operate and drive the vehicle safely. This safety-critical information may include amongst others warning signals such as “seat belt fastened” and/or the current vehicle speed, as such information can lead to accidents or even fatalities if displayed incorrectly. Invalid vehicle speed information, for example, could result in the driver not reducing the speed of the vehicle sufficiently to safely take a sharp turn, which could lead to loss of control and/or drifting off the road. Against this background, a safety concept is required that ensures the correct generation and presentation of the display content.

### BRIEF DESCRIPTION OF THE DRAWINGS

In the drawings, the same reference signs in the different views generally refer to the same parts. The drawings are not necessarily to scale; emphasis is rather generally placed on illustrating the exemplary principles of the disclosure. In the following description, various exemplary embodiments of the disclosure are described with reference to the following drawings, in which:

FIG. 1 shows an example of a vehicle display;

FIG. 2 shows a simplified, conventional device for ensuring the integrity of display data using a CRC character;

FIG. 3 shows a safety device;

FIG. 4 shows a process flow of the safety checker; and

FIG. 5 shows a safety device.

### DESCRIPTION

The following detailed description refers to the accompanying drawings, which illustratively show exemplary details and embodiments in which aspects of the present disclosure may be implemented.

The word “exemplary” is used herein with the meaning “serving as an example, case or illustration”. Any embodiment described herein as “exemplary” is not necessarily to be construed as preferred or advantageous over other embodiments or designs.

It should be noted in the drawings that identical reference signs are used to represent the same or similar elements, features and structures, unless indicated otherwise.

The wording “at least one” and “one or more” may be understood to include a numerical quantity greater than or equal to one (e.g., one, two, three, four, [ . . . ], etc.). The wording “at least one of” with respect to a group of elements may be used herein to mean at least one element of the group consisting of the elements. For example, the wording “at least one of” with respect to a group of elements may be used herein to mean a selection of the following: one of the listed elements, a plurality of one of the listed elements, a plurality of individual listed elements, or a plurality of several individual listed elements.

The words “plurality” and “several” in the description and in the claims explicitly refer to a set of more than one. Accordingly, any formulations explicitly reciting the above-mentioned words (e.g., “plurality of [elements]”, “several [elements]”) that refer to a set of elements explicitly refer to more than one of the elements. For example, the wording “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., refer in the description and in the claims, if any, to a set equal to or greater than one, i.e., one or more. The expressions “true subset”, “reduced subset” and “smaller subset” refer to a subset of a set that is not equal to the set, illustratively referring to a subset of a set that contains fewer elements than the set.

The term “data” as used herein may be understood to include information in any suitable analog or digital form provided, for example, as a file, a part of a file, a set of files, a signal or a stream, a part of a signal or stream, a set of signals or streams, and the like. Further, the term “data” may also be used to mean a reference to information, for example in the form of a pointer. However, the term “data” is not limited to the foregoing examples and may take various forms and represent any information as understood in the art.

The terms “processor” or “controller” as used herein, for example, may be understood as any type of technological entity that allows the handling of data. The data may be handled according to one or more specific functions performed by the processor or controller. Further, as used herein, a processor or controller may be understood as any type of circuit, such as any type of analog or digital circuit. Thus, a processor or controller may be or include an analog circuit, a digital circuit, a mixed-signal circuit, a logic circuit, a processor, a microprocessor, a central processing unit (CPU), a graphics processing unit (GPU), a digital signal processor (DSP), a field programmable gate array (FPGA), an integrated circuit, an application specific integrated circuit (ASIC), etc., or any combination thereof. Any other type of implementation of the respective functions described in more detail below may also be understood to be a processor, controller or logic circuit. It will be understood that any two (or more) of the processors, controllers, or logic circuits described in detail herein may be realized as a single entity having equivalent functionality or the like, and conversely, that any single processor, controller, or logic circuit implemented herein may be realized as two (or more) separate entities having equivalent functionality or the like.

As used herein, “memory” is understood to mean a storage element or computer-readable medium (e.g., a non-volatile computer-readable medium) in which data or information can be stored for retrieval. References included herein to “memory” may thus be construed to refer to volatile or non-volatile memory, including amongst others random access memory (RAM), read-only memory (ROM), flash memory, semiconductor memory, magnetic tape, a hard disk, an optical drive, 3D XPoint™, or any combination thereof. Also included in the term memory herein are, amongst others, registers, shift registers, processor registers, data buffers, etc. Memory may be local memory, wherein the memory is electrically conductively connected to a processor that reads data from and/or stores data in the memory. Alternatively or additionally, memory may be remote memory, such as memory accessed by a processor via a communication protocol (e.g., via an Internet protocol, a wireless communication protocol, etc.). Remote storage may include cloud storage. The term “software” refers to any type of executable instruction, including firmware.

Unless expressly stated, the term “transmit” includes both direct transmission (point-to-point) and indirect transmission (via one or more intermediate points). Similarly, the term “receive” includes both direct and indirect reception. Further, the terms “transmit”, “receive”, “communicate” and other similar terms include both physical transmission (e.g., the transmission of radio signals) and logical transmission (e.g., the transmission of digital data over a logical connection at the software level). For example, a processor or controller may transmit or receive data with another processor or another controller in the form of radio signals over a software-level link, where the physical transmission and the physical reception are handled by radio layer components, such as RF transceivers and antennas, and the logical transmission and the logical reception are handled by the processors or controllers over the software-level link. The term “communicate” includes transmitting and/or receiving, i.e. unidirectional or bidirectional communication in one or both of the incoming and outgoing directions. The term “calculate” includes both “direct” calculations via a mathematical expression/mathematical formula/relationship and “indirect” calculations via lookup or hash tables and other array indexing or searching operations.

To ensure that safety-critical information is displayed correctly, vehicles generally use a monitoring approach. In this way, current vehicle displays generally use known and fixed (e.g. constant, unchanging) reference images for their safety-relevant content. The integrity of these fixed images is usually checked using a CRC (cyclic redundancy check) mechanism.

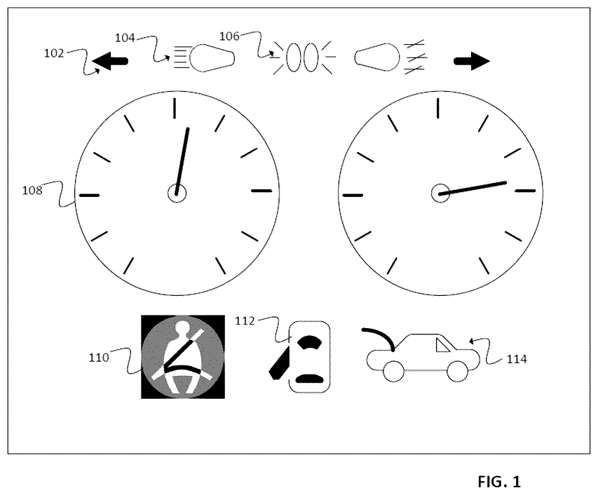

FIG. 1 shows an example of a vehicle display showing various indications or warnings. In particular, this example of a vehicle display includes various icons or images indicating whether a turn signal is activated 102, whether a headlight is activated 104, whether the high beam is activated 106, the current vehicle speed 108, whether a seatbelt is engaged 110, whether a door is ajar 112, and whether the trunk is open 114, or a collision warning. Some of these displays can be safety-critical. For example, vehicle speed 108, seat belt engagement 110, and the opening of a door 112 may be critical to whether the driver is able to maintain safety for themselves and/or their passengers. Therefore, it is critical to confirm whether the information displayed on the screen matches the intended information (e.g., to confirm that it is being displayed and/or is being displayed correctly). In other words, the integrity of the safety-critical data to be displayed on a screen should be guaranteed.

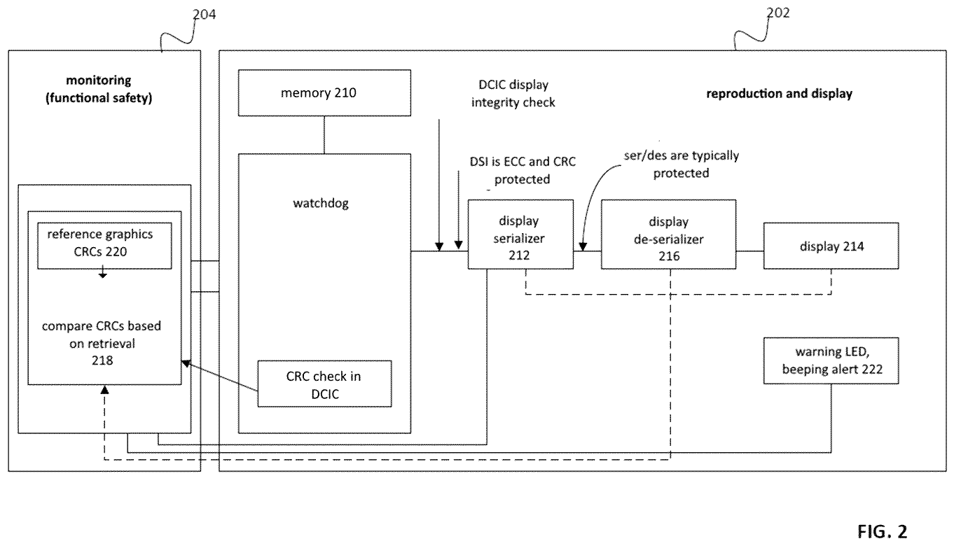

FIG. 2 shows a simplified, conventional device for ensuring the integrity of display data using a CRC (cyclic redundancy check). In this figure, the images for the display are generated in 202 and the integrity of the data is determined in 204. Specifically, predefined/pre-stored security images are read from the memory 210 and are serialized 212 into a composite display image, which is then delivered to the display 214. The composite image is then de-serialized 216 to restore the individual security images, which are sent to the functional safety unit 204. In the functional safety unit, CRCs 218 are calculated from the de-serialized images, and these CRCs are compared to the stored CRCs 220 corresponding to the predefined/pre-stored security images in the memory 210. If the calculated CRC matches the CRC of a stored security image, the image is confirmed as correctly displayed. However, if the calculated CRC does not match the CRC of a stored security image, it is determined that the image to be displayed differs from the stored security image and an error signal is generated. This can lead, for example, to an acoustic or visual warning 222.

In other words, after the image to be displayed has been created/rendered, the monitor calculates a CRC value for the area in which the safety-relevant content is to be displayed, which is then compared with the known reference CRC value. Since the safety-critical image is unchangeable, it should always provide the same expected CRC result. However, if a safety-critical image is altered or otherwise inaccurately or incompletely presented on the display, the safety-critical information will produce a different CRC value than the expected CRC value, indicating an error in the presentation of the safety-critical information. This strategy, which is also easy to implement, limits implementation and scalability because any change to the security image (e.g. size, color, animation, bit errors, etc.) is likely to result in a CRC mismatch.

For example, the corresponding vehicle displays are being converted to displays with a higher resolution (e.g. 4K displays). This increases the amount of data to be checked with the CRC. In addition, the larger number of pixels increases the likelihood of a damaged pixel, which can lead to false alarms during the CRC check, even if such a damaged pixel would otherwise not affect the safety/readability of the safety-critical content. For example, on a high-resolution screen, a single damaged pixel in a vehicle speed display would be extremely unlikely to affect the readability of the displayed speed; however, such a speed display with a damaged pixel would probably fail the conventional CRC check.

Furthermore, the emergence of L2+ and L3 systems in particular will also increase the amount of safety-relevant content in the displays. This means that, in addition to the conventional information, vehicles will probably display visualizations of the lane, the surroundings, relevant objects, etc. This increases the number of safety-critical displays to be shown and thus the probability of errors.

This approach restricts the display content to the use of ready-made images and bitmaps. This restricts the freedom of the designers when creating the context. For example, if an animation (e.g. a motion effect) is to be displayed, all sequences of the animation would have to be precompiled or at least the CRC values would have to be created in advance. This also applies to changes to improve contrast, to zoom or to change color schemes. In other words, each change should either be created in advance or a special mechanism should be in place to handle these cases.

To summarize, the shortcoming of existing safety checks is that they require an exact pixel-level reference representation of how something should be displayed. Therefore, any change in the way the image should be displayed (e.g. change of color, post-processing effects, scaling, distortion, etc.) requires an adjustment of the checking device or otherwise results in an error message.

With this in mind, a safety device (e.g., a checking mechanism) is disclosed that can interpret and check the correctness of the displayed content even if the actual pixels differ slightly from an expected value. This safety device can detect incorrect information to be displayed in the vehicle's instrument cluster or infotainment system, for example by an artificial intelligence (AI)-based image checking mechanism. This allows an AI to recognize situations where incorrect or corrupted information is generated by or within the rendering pipeline and inform the human driver of the error.

This safety device can be used in addition to an existing pipeline to detect potential errors and mitigate their consequences. Furthermore, the safety device provides a viable alternative to the conventional CRC checking mechanism, which is likely to be unusable or undesirable in the future, at least due to the scalability limitations described above, especially given that as screens increase in size and/or resolution, the likelihood of a single bit flip causing the CRC mechanism to fail increases. Finally, the current trend towards more customization and adaptation requires solutions with greater flexibility than the conventional CRC mechanism.

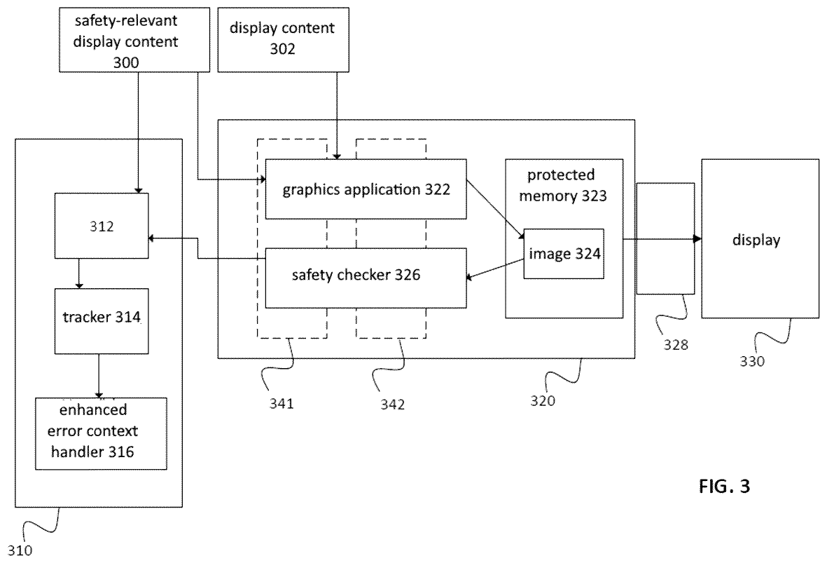

FIG. 3 shows a safety device. In this figure, the elements of the safety device are divided into data generation/data source (corresponding to 300 and 302), controller/processor 310, rendering pipeline 320 and display 330. The data generation/data source module(s) comprise(s) safety-relevant display content 300 and display content 302, i.e. the content to be displayed is divided into safety-relevant content (corresponding to 300) and non-safety-relevant content (corresponding to 302). The rendering pipeline has a graphics application 322, a protected memory 323 and a safety checker 326. The safety-relevant content 300 is sent to the graphics application 322 together with the display content 302 and relevant configurations. There, the image to be displayed on the vehicle display(s) is created. That is, the graphics application 322 receives display data (whether safety relevant or not) and generates the corresponding images for display. This image 324 to be displayed is stored in a protected memory 323. The image 324 to be displayed is then processed by the safety checker 326.

The safety checker 326 is a system that can be implemented using artificial intelligence and that is trained to recognize the relevant content of the image. For example, the safety checker 326 can be trained to recognize (e.g., extract) the speed to be displayed on the speedometer from an image of a speedometer. This may be applied to any image for display and may include, amongst others, the speed of the vehicle, whether a seatbelt is fastened, whether a door is closed, whether a warning light is on/off, whether a parking brake is applied, whether a motor/engine control function is active, the current tire pressure, or other.

With respect to the particular artificial intelligence of the safety checker 326, any artificial intelligence capable of extracting data from an image is acceptable. In an exemplary configuration, a recurrent neural network (or a detector similar to a recurrent neural network) may be used. A recurrent neural network may be trained to determine/recognize both the displayed content and the size and/or position of the displayed content. In an optional configuration, the safety checker 326 is capable of providing an uncertainty value for a particular result. For example, the safety checker 326 may determine with 92% confidence that the speed to be displayed in the speedometer image is 50 km/h. Such uncertainty values can be determined, for example, by Bayesian inference. In this way, the probability or certainty of the detected safety value can be updated or improved as additional information becomes available.

Within the controller/processor 310, a comparator circuit 312 receives the safety-relevant information 300 on the basis of which the image was created, as well as the safety-relevant information extracted from the image by the safety checker 326. This information is then compared with each other in the comparator circuit 312. If these values match (e.g., if they are identical, or alternatively, if they have a predetermined level of similarity), then the image 324 travels from the detected memory 323 to the display 330 via the transport protection 328 (e.g., a protected path between the protected memory 323 and the display). However, if the values do not match (if they are not identical or if they are dissimilar beyond a predetermined acceptable level), then the error/context handler 316 sends an error signal to the rendering pipeline 320 (for example, this may be sent to a CPU 341 in the rendering pipeline or to a GPU 342 in the rendering pipeline), resulting in the image 324 not being displayed on the display 330. Instead of displaying the image 324 on the display 330, the image 324 may optionally be blacked out or optionally replaced by one or more error messages.

However, without additional measures, this procedure can lead to a considerable number of false alarms (an alarm or error message if only an insignificant deviation from an ideal image is displayed or a deviation from the ideal image is only of such short duration that it is insignificant).

In order to reduce the number of false alarms, it is possible to add an optional tracking circuit 314 after comparing the results. It is expressly pointed out that many displays can operate at 60 Hz (displays with other frequencies, e.g. 50 Hz, are also conceivable) and therefore an error within a single frame or up to a few frames would not be recognizable to the human eye. Thus, an incorrect display can be tolerable for a short period of time (e.g. fractions of a second) and does not require an error message or other measures. In this way, the tracking circuit 314 may be configured in conjunction with the protected memory 323 to implement a small delay sufficient to determine whether an error (a mismatch between the safety-related data and the data extracted by the checker 326) is repeated over a sufficiently long period of time that it may be detectable to the human eye. Such a delay may be configured based on desirable tolerances. In one configuration, the delay may be about 33 ms to approximate the time it takes the human eye to perceive an image (which may be about 1/30 of a second).

As can be seen from the above, it may be desirable or even necessary for the comparator circuit 312 to operate within one or more predefined tolerances. In particular, one or more predefined safety tolerances may be programmed to represent a difference between the safety-relevant display content 300 and the extracted data from the checker 326 that represent a safety-critical difference. For example, the safety checker 326 may not provide the exact value that was intended in a graphical representation of the vehicle speed (e.g., the safety checker 326 provides a value of 21 km/h instead of 20 km/h), but such a difference is not safety-critical and would therefore be tolerable. Furthermore, the comparator circuit 312 may be configured to compare not only the data relevant to safety in terms of content, but also the size and position of the data. In this way, the safety checker 326 can determine the size and position of the safety-relevant data and send it to the comparator circuit 312 for comparison with the safety-relevant display content 300. In many cases, even small to moderate differences in size or position of these data will not be safety-critical, so that an appropriate tolerance can be introduced. Although the skilled person will be aware that such tolerances can be implemented according to a number of techniques, one such suitable technique would be the use of intersection over union, which can be configured to quantify the degree of overlap between two images (e.g., between two boxes).

It is expressly noted that the elements shown in FIG. 3 are shown as separate functional components for demonstration purposes and do not necessarily require each element to be configured in a separate physical unit. For example, many of the elements in FIG. 3 may be implemented in software and run on a common processor together with one or more of the other elements in FIG. 3.

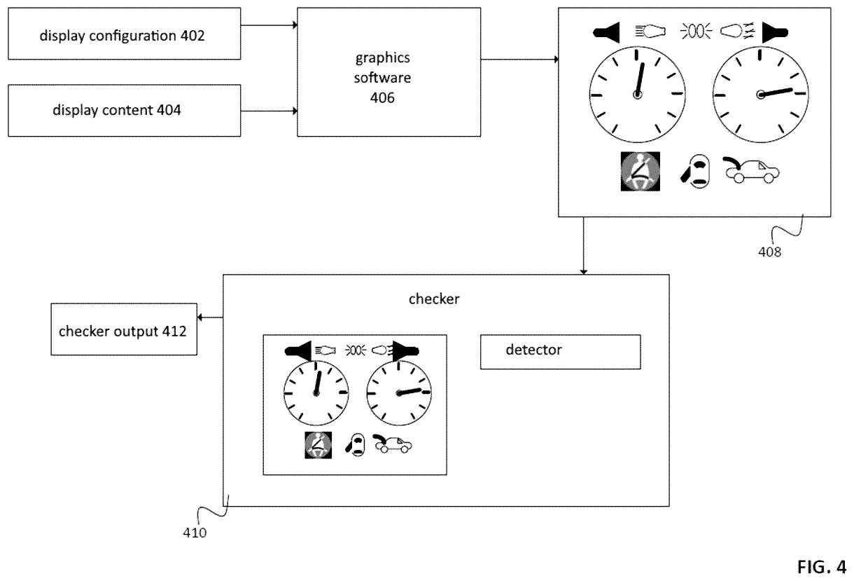

FIG. 4 illustrates the safety checking process by the safety checker as described herein. In this figure, display configuration information 402 (e.g., locations and/or size of information to be displayed) and display content 404 are sent to graphics software (e.g., graphics application) 406, which uses this information to generate a display image 408. It should be noted that the display content 404 is shown in FIG. 3 as display content 302 and safety-related display content 300. The display image is then provided to the safety checker 410, which extracts the safety-relevant information from the image (e.g., extracts a speed from the speedometer image, extracts whether a seatbelt is fastened from a seatbelt image, etc.) and provides this information to the safety checker output 412, where it is then compared to the safety-relevant data to be displayed as described herein. The safety checker 410 may utilize one or more neural networks to perform its functions as described herein.

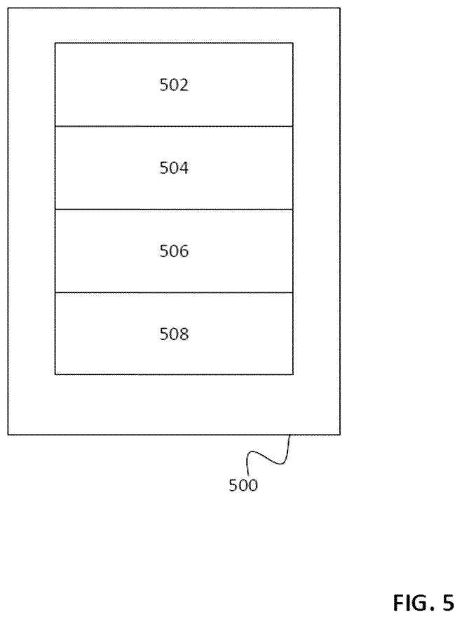

FIG. 5 shows a safety device 500 comprising an image data analyzer 502 configured to receive data representing an image for display on a vehicle display; to identify a safety-relevant part of the image based on the data; and to determine a value representing the identified safety-relevant part of the image. The safety device 500 further comprises a safety checker 504 configured to compare the value to a reference value, wherein the safety device 500 is configured to implement a first mode of operation if the comparison of the value with the reference value is within a comparison range; and to implement a second mode of operation that is different from the first mode of operation if the comparison of the value with the reference value is outside the comparison range.

The image data analyzer 502 of the safety device 500 may further be configured to determine an uncertainty of the value. In this way, the uncertainty value may indicate the certainty of a particular safety value that the image data analyzer 502 has extracted from the image datum. The safety device may further be configured to perform the second mode of operation if the comparison of the value with a predetermined reference value is within a range, but the uncertainty value is outside a range of an acceptable uncertainty value. In this way, a maximum uncertainty value may be generated such that a certain level of uncertainty beyond the maximum uncertainty value is considered unacceptable (e.g., too great a risk).

The safety device 500 may further comprise a tracking circuit 506. The tracking circuit 506 may be configured to determine a set of successive values, calculated from successive images for display on the vehicle display, that are different from the reference value. The safety device may then further be configured to implement the second mode of operation if the comparison of the value with the reference value is within the comparison range, but the number of successive values that differ from the reference value exceeds a threshold value. In this way, the tracking circuit 506 can distinguish between short one-time errors and/or a short series of errors and errors of longer duration. As a point of reference, the threshold between an acceptable error duration and an unacceptable error duration may be a duration that is necessary to be visible to the human eye. This can be, for example, a duration of around 33 ms; in this regard, a longer or shorter duration can be selected depending on the design.

The safety device 500 may further comprise a secure memory 508 configured to store the data. Storing the data may comprise receiving the data using the image data analyzer.

Throughout this disclosure, reference is made to “safety-relevant data”. Such safety-relevant data may include amongst others vehicle speed, whether a seat belt is fastened, whether a door is closed, whether a warning is present, whether the parking brake is applied, whether a motor/engine control function is active, current tire pressure, or other. The skilled person will understand that many other types of safety-relevant information can be displayed, and the principles and methods described herein can be applied without further limitation to any type of safety-relevant information for display in a vehicle.

The principles and methods described herein do not rely on prior information, although they may utilize and/or take advantage of prior information, such as expected position, size, or value, if available. For example, depending on whether position information is available, either the entire image or (if specific position information is available for particular safety-related data) only a part of the image (only a region of interest) can be analyzed. Limiting the analysis to one or more regions of interest creates a new flexibility in the methods described herein for reviewing safety information, since regions of interest typically exclude the background, allowing for significant or often unlimited changes to the background, such as altered contrasts or colors, or even potentially different information to be displayed. In other words, the principles and methods described herein allow for a fully customizable instrument cluster instead of the fixed and non-customizable instrument cluster required by standard safety checking practices.

In an optional configuration, the safety checker 326 may be configured to use one or more redundant methods. The decision to use one or more redundant methods may depend, for example, on a security and vulnerability analysis of the final system. Such redundancy may be realized by using two or more neural networks (e.g., the neural networks as part of the AI in the safety checker 326). This can be accomplished by using multiple redundant neural networks (e.g., two or more identical neural networks) whose results can be compared to ensure accuracy.

Alternatively or additionally, this may be realized by using multiple different neural networks. In such a configuration, the safety checker 326 may be configured as two different neural networks such that an area detection neural network recognizes the areas where relevant objects are located, and a content inspection neural network then classifies the contents of those areas. In this way, these two neural networks would be understood as part of the safety checker 326. This is, of course, only one example of how the functions of the safety checker 326 may be divided between multiple neural networks. The skilled person will understand that other configurations are also possible. In the context of redundancy, it is also possible to use different network topologies or to run the same network twice, assuming at least some independence between the networks. This can be achieved, for example, by using different areas of a memory.

Although safety-critical systems have not yet relied on AI-based solutions, at least some attempts are being made to incorporate AI into safety-critical systems and this is expected to become more commonplace. In addition, the integration of AI into safety-critical systems can at least be supported by the International Organization for Standardization's ISO/PAS 21448 “Safety of intended functionality” standard.

Other factors speak in favor of using AI in such a safety-critical system. Firstly, the AI detector (e.g. the safety checker 326) is only used to check against an expected value. Therefore, the detection rate is expected to be very high (i.e. >99.9%, which corresponds to the range of an ASIL-B (Automotive Safety Integrity Level) certification). Secondly, a missed detection (e.g. a false detection) of the AI system may cause a false alarm as the false detection does not match the expected value. It is unlikely that an error in the output image will be masked by an error in the safety checker. For example, an error in the graphics application 322 will result in a faulty image not being displayed. However, a masking error would require the safety checker to incorrectly recognize the expected warning sign and its position and size. The probability of such an event is very low. For this point, the probability of failure is the probability that an error is generated in the display pipeline 320, multiplied by the probability of a false positive result from the safety checker 326. An illustrative example: Quality management (QM) hardware typically has an expected failure rate of 1 failure in 10,000 hours of operation. Assuming that a well-trained detector network can achieve an accuracy of 99.99% for this task, the combined failure rate is in the order of 10⁶ hours, which is within an acceptable range for ASIL-A certification.

To the extent that the safety checker 326 is susceptible to certain permanent errors, there are mechanisms that can provide adequate protection against these errors. Using redundant sensors, refreshing the memory (e.g. the weights of the neural network) and checking the output of the safety checker 326 using reference images, which can be used individually or in combination with each other, reduce the likelihood of a permanent error, so that the likelihood of a permanent error becomes acceptable.

The above considerations can also be applied to hardware failures. In general, a hardware failure that causes a missing detection (a failed detection or a false or incorrect detection) will result in a false alarm. A hardware failure that leads to correct results is unlikely and would have to occur in parallel with a failure on the nominal path to lead to a failure.

In general, each detector described here can lead to two types of errors. First, there are false negatives (FN), which occur if the detector fails to recognize an object. Second, there are false positives (FP), i.e., errors where the detector recognizes an object, although there is actually no object in the input data. In any detection system, there is a dependency between FNs and FPs, which can be considered the security of the system. For example, if the system is configured to only output objects with a high level of security, the number of FNs increases and the FPs are reduced. If, on the other hand, low security is required, the number of FPs increases and the number of FNs decreases.

With the safety checker described here, the FNs do not lead to a safety risk. This means that if the network does not detect a required object, an alarm is triggered. As this alarm is caused by a malfunction of the checking device, it is a false alarm, which is undesirable and may limit the usability of the system. However, it does not represent a safety problem. Only FPs are safety-relevant, as they may conceal an error in the graphics application. However, steps can be taken to reduce the likelihood of such a masking error. First, the required confidence can be increased, reducing the likelihood of an FP. Secondly, it is possible to add redundant detectors with a selector mechanism. Thus, an object can only be accepted as detected if it is reported by all/the majority of the detectors.

In terms of error handling, the AI detector of the safety checker 326 is not only able to identify false/incorrect information within the rendered image to be displayed, but can also provide information on the nature of the error. For example, if the speed display is validated and an error is detected, a conventional CRC-based solution could only report that the displayed speed is incorrect. However, the principles and methods presented here can also provide additional information about whether the displayed speed is too high or too low. In some cases it is sufficient to inform the driver that the displayed speed is incorrect, in other cases a specific warning that the vehicle is traveling faster than indicated can be of particular value and may increase safety (e.g. the driver can slow down to avoid unsafe situations).

It should also be noted that any error message that is to be displayed should be rendered and should therefore be checked like any other rendered image. Due to the flexibility of the safety checker presented here, such validation of a rendered error message is possible without overhead. In contrast, the conventional CRC-based approaches would again reach the limits of scalability. The safety checker described here therefore not only enables more customizable dashboards, but can also be used to improve error handling/error reporting with context-specific or error-specific information.

While the components are shown as separate elements in the above descriptions and accompanying figures, those skilled in the art will appreciate the various ways in which discrete elements can be combined or integrated into a single element. These include combining two or more circuits into a single circuit, assembling two or more circuits on a common chip or chassis to form an integrated element, running discrete software components on a common processor core, etc. Conversely, those skilled in the art will recognize the possibility of splitting a single element into two or more discrete elements, such as splitting a single circuit into two or more separate circuits, splitting a chip or chassis into discrete elements originally intended on it, splitting a software component into two or more portions and running them on a separate processor core, etc.

Further aspects of the disclosure are illustrated using examples.

Example 1 is a safety device comprising an image data analyzer configured to receive data representing an image for display on a vehicle display; to identify a safety-relevant part of the image based on the data; to determine a value representing the identified safety-relevant part of the image; and a safety checker configured to compare the value with a reference value; wherein the safety device is configured to implement a first mode of operation if the comparison of the value with the reference value is within a comparison range; and to implement a second mode of operation which is different from the first mode of operation if the comparison of the value with the reference value is outside the comparison range.

In Example 2, the subject matter of Example 1 may optionally comprise that the image data analyzer is further configured to determine an uncertainty of the value; and wherein the safety device is further configured to implement the second mode of operation if the comparison of the value with the reference value is within the comparison range but the uncertainty is outside an uncertainty range.

In Example 3, the subject matter of Examples 1 or 2 may optionally comprise a tracking circuit configured to determine a set of successive values calculated from successive images for display on the vehicle display that are different from the reference value; and wherein the safety device is further configured to implement the second mode of operation if the comparison of the value with the reference value is within the comparison range but the number of successive values that are different from the reference value exceeds a threshold value.

In Example 4, the subject matter of any one of Examples 1 to 3 may optionally comprise that the safety checker is implemented by a processor corresponding to Automotive Safety Integrity Level D according to Part 9 of International Organization for Standardization (ISO) Standard 26262.

In Example 5, the subject matter of any one of Examples 1 to 4 may optionally comprise a secure memory configured to store the data, wherein receiving the data by means of the image data analyzer comprises receiving the data from the secure memory.

In Example 6, the subject matter of any one of Examples 1 to 5 may optionally comprise that the safety-relevant part of the image comprises a part of the image indicating at least one of the following: vehicle speed; whether a seatbelt is fastened; whether a door is closed; a warning; whether a parking brake is applied; whether a motor/engine control function is active; and/or tire pressure.

In Example 7, the subject matter of any one of Examples 1 to 6 may optionally comprise that the value indicates at least one of the following: a vehicle speed; a seatbelt fastened or unfastened; an open or closed door; the presence or absence of a warning; the application of a parking brake; the activity of a motor/engine control function; and/or a tire pressure.

In Example 8, the subject matter of any one of Examples 1 to 7 may optionally comprise that identifying the safety-relevant part of the image comprises analyzing the data to identify data representing a part of the image indicating a safety-relevant part of the image.

In Example 9, the subject matter of any one of Examples 1 to 8 may optionally comprise that the analysis of the data is performed using an artificial neural network to identify data representing the part of the image that indicates a safety-relevant part of the image.

In Example 10, the subject matter of Example 9 may optionally comprise that the artificial neural network is a recurrent neural network.

In Example 11, the subject matter of Example 9 may optionally comprise that the artificial neural network is a convolutional neural network.

In Example 12, the subject matter of any one of Examples 1 to 11 may optionally comprise that the second mode of operation comprises sending a signal indicating an error.

In Example 13, the subject matter of any one of Examples 1 to 12 may optionally comprise that the first mode of operation comprises not sending a signal indicating an error.

In Example 14, the subject matter of any one of Examples 12 or 13 may optionally comprise that the signal indicating the error is a signal that causes an error message to be displayed on the display.

In Example 15, a method for analyzing image data is provided, comprising receiving data representing an image for display on a vehicle display; identifying a safety-relevant part of the image on the basis of the data; determining a value representing the identified safety-relevant part of the image; and comparing the value to a reference value; implementing a first mode of operation if the comparison of the value with the reference value is within a comparison range; and implementing a second mode of operation different from the first mode of operation if the comparison of the value with the reference value is outside the comparison range.

In Example 16, the method of Example 15 may optionally comprise determining an uncertainty of the value; and implementing the second mode of operation if the comparison of the value with the reference value is within the comparison range but the uncertainty is outside an uncertainty range.

In Example 17, the method of any one of Examples 15 or 16 may optionally comprise determining a set of successive values calculated from successive images for display on the vehicle display that are different from the reference value; and implementing the second mode of operation if the comparison of the value with the reference value is within the comparison range but the number of successive values that are different from the reference value exceeds a threshold value.

In Example 18, the subject matter of any one of Examples 16 or 17 may optionally comprise that the safety checker is implemented by a processor corresponding to Automotive Safety Integrity Level D according to Part 9 of International Organization for Standardization (ISO) Standard 26262.

In Example 19, the subject matter of any one of Examples 15 to 18 may optionally comprise a secure memory configured to store the data; wherein receiving the data by means of the image data analyzer comprises receiving the data from the secure memory.

In Example 20, the subject matter of any one of Examples 15 to 19 may optionally comprise that the safety-relevant part of the image comprises a part of the image indicating at least one of the following: vehicle speed; whether a seatbelt is fastened; whether a door is closed; a warning; whether a parking brake is applied; whether a motor/engine control function is active; and/or tire pressure.

In Example 21, the subject matter of any one of Examples 15 to 20 may optionally comprise that the value indicates at least one of the following: a vehicle speed; a seatbelt fastened or unfastened; an open or closed door; the presence or absence of a warning; the application of a parking brake; the activity of a motor/engine control function; and/or a tire pressure.

In Example 22, the subject matter of any one of Examples 15 to 21 may optionally comprise that identifying the safety-relevant part of the image comprises analyzing the data to identify data representing a part of the image indicating a safety-relevant part of the image.

In Example 23, the subject matter of any one of Examples 15 to 22 may optionally comprise that the analysis of the data is performed using an artificial neural network to identify data representing the part of the image that indicates a safety-relevant part of the image.

In Example 24, the subject matter of Example 23 may optionally comprise that the artificial neural network is a recurrent neural network.

In Example 25, the subject matter of Example 23 may optionally comprise that the artificial neural network is a convolutional neural network.

In Example 26, the subject matter of any one of Examples 15 to 25 may optionally comprise that the second mode of operation comprises sending a signal indicating an error.

In Example 27, the subject matter of any one of Examples 15 to 26 may optionally comprise that the first mode of operation comprises not sending a signal indicating an error.

In Example 28, the subject matter of any one of Examples 26 or 27 may optionally comprise that the signal indicating the error is a signal that causes an error message to be displayed on the display.

In Example 29, a non-transitory computer readable medium is provided, comprising instructions that, if executed by a processor, cause the processor to perform the method of any one of Examples 15-29.

In Example 30, the subject matter of any one of Examples 1 to 14 may optionally comprise that the safety-relevant part of the image is located at a predefined location; and wherein identifying the safety-relevant part of the image using the data comprises reading data from the predefined location and determining the value of these data.

In Example 31, the subject matter of any of Examples 1 to 14 may optionally comprise that the safety checker 504 is implemented by several processors according to Automotive Safety Integrity Level D as defined in Part 9 of International Organization for Standardization (ISO) Standard 26262.

In Example 32, the subject matter of any one of Examples 1 to 14 may optionally comprise that the safety-relevant part of the image comprises a part of the image indicating a warning; and wherein this warning is a collision warning.

In Example 33, the subject matter of any one of Examples 1 to 14 may optionally comprise that the collision warning indicates a hazardous object.

In Example 34, the subject matter of any one of Examples 1 to 14 may optionally comprise that the hazardous object is a car or a pedestrian.

It is understood that implementations of the methods described herein are demonstrative in nature and can therefore be implemented in a corresponding device. Similarly, it is understood that implementations of the devices described herein may be implemented as a corresponding method. It will therefore be understood that a device corresponding to a method described herein may include one or more components configured to perform any aspect of the corresponding method.

All acronyms defined in the above description also apply to all claims contained herein.

1. A safety device, comprising:
an image data analyzer that is configured to:
receive data representing an image for display on a vehicle display;
identify a safety-relevant part of the image based on the data; and
determine a value that represents the identified safety-relevant part of the image; and
a safety checker configured to compare the value with a reference value;
wherein the safety device is configured to:
implement a first mode of operation if the comparison of the value to the reference value is within a comparison range; and
implement a second mode of operation different from the first mode of operation if the comparison of the value with the reference value is out of the comparison range.

2. The safety device of claim 1,
wherein the image data analyzer is further configured to determine an uncertainty of the value; and
wherein the safety device is further configured to implement the second mode of operation if the comparison of the value to the reference value is within the comparison range but the uncertainty is outside an uncertainty range.

3. The safety device of claim 1, further comprising:
a tracking circuit configured to determine a set of successive values calculated from successive images for display on the vehicle display that differ from the reference value; and wherein the safety device is further configured to implement the second mode of operation if the comparison of the value to the reference value is within the comparison range, but the number of successive values that differ from the reference value exceeds a threshold value.

4. The safety device of claim 1,
wherein the safety checker is implemented by a processor corresponding to Automotive Safety Integrity Level D as defined in Part 9 of International Organization for Standardization Standard 26262.

5. The safety device of claim 1, further comprising:
a secure memory that is configured to store the data;
wherein receiving the data by means of the image data analyzer comprises receiving the data from the secure memory.

6. The safety device of claim 1,
wherein the safety-relevant part of the image comprises a part of the image indicating at least one of the following:
the vehicle speed;
whether a seat belt is fastened;
whether a door is closed;
a warning;
whether a parking brake is applied;
whether a motor/engine control function is active;
a collision warning, and/or
the tire pressure.

7. The safety device of claim 1,
wherein the value indicates at least one of the following:
a vehicle speed;
whether a seat belt is fastened or whether a seat belt is not fastened;
an open or closed door;
the presence or absence of a warning;
the application of a parking brake;
the activity of a motor/engine control function;
a collision warning, and/or
a tire pressure.

8. The safety device of claim 1,
wherein identifying the safety-relevant part of the image comprises analyzing the data to identify data representing a part of the image indicating a safety-relevant part of the image.

9. The safety device of claim 8,
wherein the analysis of the data is performed using an artificial neural network to identify data representing the part of the image that indicates a safety-relevant part of the image.

10. The safety device of claim 9,
wherein the artificial neural network is a recurrent neural network.

11. The safety device of claim 9,
wherein the artificial neural network is a convolutional neural network.

12. The safety device of claim 1,
wherein the second mode of operation comprises sending a signal indicating an error.

13. The safety device of claim 1,
wherein the first mode of operation comprises not sending a signal indicating an error.

14. The safety device of claim 12,
wherein the signal indicating the error is a signal that causes an error message to appear on the display.

15. The safety device of claim 1, wherein the safety device is configured as a vehicle or as a part of a vehicle.

16. A method for analyzing image data, comprising:
receiving data representing an image for display on a vehicle display;
identifying a safety-relevant part of the image based on the data;
determining a value that represents the identified safety-relevant part of the image; and
comparing the value with a reference value;
implementing a first mode of operation if the comparison of the value with the reference value is within a comparison range; and
implementing a second mode of operation different from the first mode of operation if the comparison of the value with the reference value is out of the comparison range.

17. The method of claim 16,
further comprising determining an uncertainty of the value; and
implementing the second mode of operation if the comparison of the value with the reference value is within the comparison range, but the uncertainty is outside an uncertainty range.

18. The method of claim 16, further comprising:
determining a set of successive values calculated from successive images for display on the vehicle display that differ from the reference value; and
implementing the second mode of operation if the comparison of the value with the reference value is within the comparison range, but the number of successive values different from the reference value exceeds a threshold.

19. The method of claim 16,
wherein the safety checker is implemented by a processor corresponding to Automotive Safety Integrity Level D as defined in Part 9 of International Organization for Standardization (ISO) Standard 26262.

20. A non-transitory computer-readable medium comprising instructions that, if executed by a processor, cause the processor to:
receive data representing an image for display on a vehicle display;
identify a safety-relevant part of the image based on the data;
determine a value that represents the identified safety-relevant part of the image; and
compare the value with a reference value;
implement a first mode of operation if the comparison of the value with the reference value is within a comparison range; and
implement a second mode of operation different from the first mode of operation if the comparison of the value with the reference value is out of the comparison range.
